(19) United States
(12) Patent Application Publication
(10) Pub. No.: US 2018/0083367 A1
(43) Pub. Date: Mar. 22, 2018

(54) COMMON-GROUND-PLANE ANTENNAS

(71) Applicant: QUALCOMM Incorporated, San Diego, CA (US)

(72) Inventors: Young Jun SONG, San Diego, CA (US); Guining SHI, San Diego, CA (US); Allen TRAN, San Diego, CA (US)

(21) Appl. No.: 15/272,815

(22) Filed: Sep. 22, 2016

(51) Int. Cl. H01Q 21/00; H01Q 1/48; H01Q 1/38; H01Q 1/24

(52) U.S. Cl. CPC H01Q 21/005; H01Q 1/241; H01Q 1/38; H01Q 1/48

(57) ABSTRACT

A multi-antenna structure includes: a substrate; a ground plane disposed on the substrate; a signal feed mechanism; a first antenna coupled to the ground plane via the signal feed mechanism; a second antenna coupled to the ground plane via the signal feed mechanism; and an isolator electrically coupled to the ground plane and disposed between the first antenna and the second antenna, the isolator including: a first side wall and a second side wall that define a slot; a short coupled to the first side wall and to the second side wall to define a first end of the slot; and a capacitor configured and disposed to be coupled to the first side wall and to the second side wall to define a second end of the slot.

### BACKGROUND

Communication devices, and in particular mobile communication devices, are prolific in today's society. Advances in communication device technology have brought many new functions and features to these devices. It is often desirable to provide more features in smaller form factors to increase the usefulness and usability of communication devices. Adding functionality and/or reducing size of devices may result in degradation of performance of one or more components of the devices, e.g., due to electrical interference and/or mutual coupling between components. For example, it is often desirable to have two or more antennas integrated into a single dielectric substrate in a compact layout. With antennas being close to each other and sharing a ground plane, mutual coupling between the antennas may degrade performance, and may restrict how compact the layout can be and still provide acceptable performance.

### SUMMARY

An example of a multi-antenna structure includes: a substrate; a ground plane disposed on the substrate; a signal feed mechanism; a first antenna coupled to the ground plane via the signal feed mechanism; a second antenna coupled to the ground plane via the signal feed mechanism; and an isolator electrically coupled to the ground plane and disposed between the first antenna and the second antenna, the isolator including: a first side wall and a second side wall that define a slot; a short coupled to the first side wall and to the second side wall to define a first end of the slot; and a capacitor configured and disposed to be coupled to the first side wall and to the second side wall to define a second end of the slot.

Implementations of such a structure may include one or more of the following features. The first antenna is configured to radiate, over a frequency range, at least a threshold amount of energy received from the signal feed mechanism, and wherein a length of the slot from the first end of the slot to the second end of the slot is less than an eighth of a wavelength at a center frequency of the frequency range. The capacitor is one of multiple selectable capacitors each disposed at least partially across the slot and each disposed a respective different distance from the first end. At least two of the selectable capacitors have different capacitance values. The structure further includes multiple selectable shorts each disposed a respective different distance from the first end and each configured to define a new first end of the slot when selected. The first antenna, the second antenna, the first side wall, and the second side wall are co-planar, and the first side wall and the second side wall define at least a portion of the slot between the first antenna and the second antenna. The portion of the slot between the first antenna and the second antenna is a first portion of the slot, a first portion of the first side wall and a first portion of the second side wall define the first portion of the slot, a second portion of the first side wall and a second portion of the second side wall define a second portion of the slot, and each of the first portion of the first side wall and the first portion of the second side wall has a respective first width transverse to a length of the slot that is smaller than a respective second width of the second portion of the first side wall and the second portion of the second side wall. The capacitor is a lumped capacitor, a variable capacitor, or an interdigitated capacitor. The ground plane has an upper edge above which the first antenna and the second antenna are disposed, the first end of the slot being disposed below or collinear with the upper edge of the ground plane. The ground plane has an upper edge above which the first antenna and the second antenna are disposed, the second end of the slot being disposed collinear with or below the upper edge of the ground plane.

An example of a printed circuit board includes: a dielectric substrate; a first antenna disposed on a first side of the dielectric substrate; a second antenna disposed on the first side of the dielectric substrate, co-planar with the first antenna and displaced from the first antenna by a first length; a ground plane disposed on the first side of the dielectric substrate, co-planar with the first antenna and co-planar with the second antenna, the ground plane defining a first side of a slot, a second side of the slot, and a proximal end of the slot, the slot having a second length that is substantially transverse to the first length; and a tuning mechanism comprising: at least one selectable short configured to be selectively coupled to the ground plane across the slot; or a plurality of selectable capacitances each configured to be selectively coupled to the ground plane across the slot; or a combination thereof.

Implementations of such a printed circuit board may include one or more of the following features. The tuning mechanism includes the selectable capacitances, each of the selectable capacitances being disposed a respective different distance from the proximal end of the slot. Each of the selectable capacitances has a capacitance value unique to the selectable capacitors. The tuning mechanism includes the at least one selectable short, wherein the at least one selectable short includes multiple selectable shorts each disposed a respective different distance from the proximal end of the slot. The ground plane defines the slot between the first antenna and the second antenna. The first antenna is F-shaped, with a first base portion extending transverse to an edge of the ground plane, and with upper portions extending parallel to the edge of the ground plane, the second antenna is F-shaped, with a second base portion extending transverse to the edge of the ground plane, and with upper portions extending parallel to the edge of the ground plane in a direction substantially opposite of the upper portions of the first antenna, and the ground plane defines the slot substantially parallel to and between the first base portion of the first antenna and the second base portion of the second antenna.

Another example of a printed circuit board includes: a dielectric substrate; a first antenna disposed on a first side of the dielectric substrate; a second antenna disposed on the first side of the dielectric substrate, co-planar with the first antenna and displaced from the first antenna by a first length; a ground plane disposed on the first side of the dielectric substrate, co-planar with the first antenna and co-planar with the second antenna; and means for inhibiting electrical coupling between the first antenna and the second antenna, the means for inhibiting comprising two opposing electrically-conductive walls providing a slot, means for providing an electrically-conductive first terminus of the slot, and capacitive means for providing a capacitive second terminus of the slot.

Implementations of such a printed circuit board may include one or more of the following features. The capacitive means include means for selecting a capacitance of the capacitive second terminus. The capacitive means include means for selecting a location of the capacitive second terminus. The means for inhibiting include means for selecting a location of the first terminus. The means for inhibiting are for inhibiting electrical coupling between the first antenna and the second antenna over a first frequency band, the means for inhibiting being further for radiating energy over a second frequency band that is separate from the first frequency band. The means for inhibiting include a portion of the ground plane providing the two opposing electrically-conductive walls.

An example of a method of communicating from a first antenna and a second antenna disposed on a printed circuit board includes: actuating the first antenna disposed on the printed circuit board using a first signal having a first frequency in a first frequency band, the first signal being a first communication signal; actuating the second antenna, disposed on the printed circuit board and sharing a ground plane with the first antenna, using a second signal having a second frequency in the first frequency band, the second signal being a second communication signal; inhibiting energy radiated by the first antenna from inducing current in the second antenna by receiving energy, radiated by the first antenna, at the ground plane in a region of the ground plane adjacent a slot, sides of the slot being defined by the ground plane and a first end of the slot being defined by a capacitive terminus; and inhibiting energy radiated by the second antenna from inducing current in the first antenna by receiving energy, radiated by the second antenna, at the ground plane in the region adjacent the slot.

Implementations of such a method may include one or more of the following features. The method further includes: actuating the first antenna using a third signal having a third frequency in a second frequency band that is separate from the first frequency band, the third signal being a third communication signal, the second frequency band depending on a resonance frequency of the slot; and actuating the second antenna using a fourth signal having a fourth frequency in the second frequency band, the fourth signal being a fourth communication signal. The first signal is the second signal and the third signal is the fourth signal. The method further includes: selecting a capacitance value of the capacitive terminus; or selecting a location of the capacitive terminus; or selecting a location of a second end of the slot, the second end being an electrically-conductive terminus; or a combination thereof.

### BRIEF DESCRIPTION OF THE DRAWINGS

FIG. 1 is an exploded view of a mobile communication device.

FIG. 2 is a block diagram of processing components of the mobile communication device shown in FIG. 1.

FIG. 3 is a top view of an antenna printed circuit board shown in FIG. 1.

FIG. 4 is a top view of an isolator of the antenna printed circuit board shown in FIG. 3.

FIGS. 5-9 are top views of alternative configurations of isolators.

FIG. 10 is a block flow diagram of a method of communicating using the mobile communication device shown in FIG. 1.

### DETAILED DESCRIPTION

Techniques are discussed herein for wirelessly communicating using multiple antennas that share a ground plane. For example, an isolator may be disposed between antennas that share a ground plane. The isolator comprises a slot terminated on a first end by a conductor and on a second end by a capacitor. The slot may extend partially or entirely across a region between the antennas. The length of the slot may be selected/adjusted by selectively connecting a conductor from among multiple conductors to provide the first end of the slot and/or by selectively connecting a capacitor from among multiple capacitors to provide the second end of the slot. The capacitance of the capacitor providing the second end of the slot may be selected/adjusted by selectively connecting a capacitor from among multiple capacitors having at least two different capacitance values. The isolator may itself radiate energy and may do so at a frequency outside of a frequency range of (significant) radiation by the antennas. These examples, however, are not exhaustive.

Items and/or techniques described herein may provide one or more of the following capabilities, as well as other capabilities not mentioned. For example, mutual coupling between antennas may be reduced, e.g., by an isolator receiving energy and helping to isolate the antennas. An isolator may serve multiple purposes, providing isolation between antennas (suppressing mutual coupling) and providing a radiator at a different band than the antennas. A frequency of maximum mutual coupling suppression may be reconfigurable, which may help, for example, to achieve closed-loop tuning of antenna isolation. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

The discussion below focuses on a mobile communication device such as a smartphone or a tablet. The discussion, however, is applicable to other devices including devices that are not typically mobile. The discussion is of a system with multiple antennas and a structure that suppresses mutual coupling between the antennas, and possibly provides another resonator at a frequency outside a frequency band of significant radiation by the antennas. Thus, the discussion is applicable to any system that may use multiple antennas and a mutual coupling suppressor as discussed.

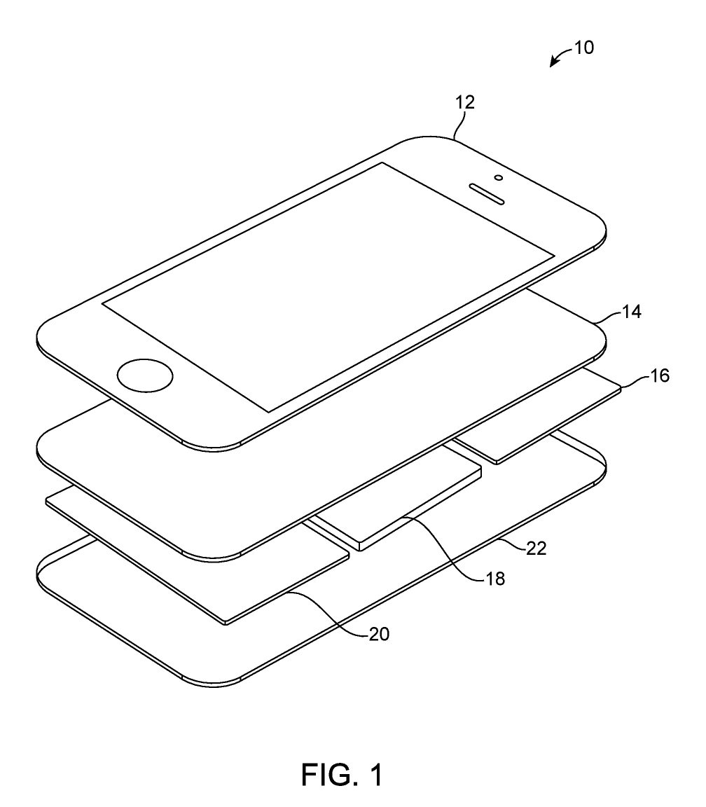

Referring to FIG. 1, a mobile device 10 includes a top cover 12, a display 14, a main printed circuit board (PCB) 16, a battery 18, an antenna PCB 20, and a bottom cover 22. The mobile device 10 as shown may be a smartphone or a tablet computer but the discussion is not limited to such devices. The antenna PCB 20 is communicatively coupled to the main PCB 16 to facilitate bi-directional communication between antennas of the antenna PCB 20 and a processor of the main PCB 16.

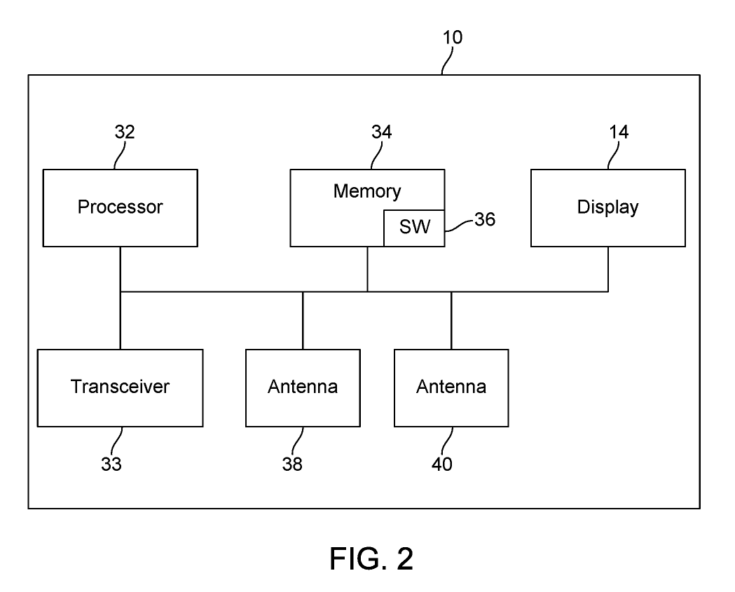

Referring to FIG. 2, with further reference to FIG. 1, the mobile device 10 comprises a computer system including a processor 32, a memory 34 including software (SW) 36, the display 14, a transceiver 33, and antennas 38, 40. The processor 32 is part of the main PCB 16 and the antennas are parts of the antenna PCB 20. The processor 32 is preferably an intelligent hardware device, for example a central processing unit (CPU) such as those made or designed by QUALCOMM®, ARM®, Intel® Corporation, or AMD®, a microcontroller, an application specific integrated circuit (ASIC), etc. The processor 32 may comprise multiple separate physical entities that can be distributed in the mobile device 10. The memory 34 may include random access memory (RAM) and/or read-only memory (ROM). The memory 34 is a non-transitory, processor-readable storage medium that stores the software 36 which is processor-readable, processor-executable software code containing instructions that are configured to, when performed, cause the processor 32 to perform various functions described herein. The description may refer only to the processor 32 performing the functions, but this includes other implementations such as where the processor 32 executes software and/or firmware. The software 36 may not be directly executable by the processor 32 and instead may be configured to, for example when compiled and executed, cause the processor 32 to perform the functions. Whether needing compiling or not, the software 36 contains the instructions to cause the processor 32 to perform the functions. The processor 32 is communicatively coupled to the memory 34 and to the antennas 38, 40 via the transceiver 33. The transceiver 33 is communicatively coupled to the processor 32 and to the antennas 38, 40. The processor 32 in combination with the memory 34 provide means for performing functions as described herein.

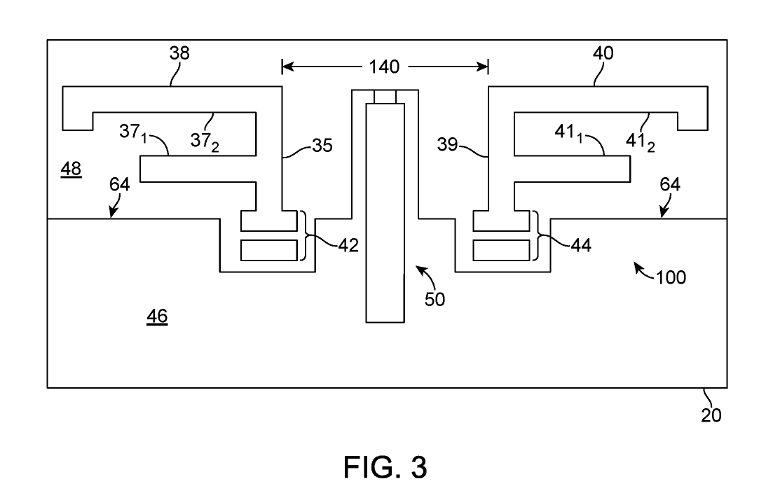

Referring to FIG. 3, with further reference to FIGS. 1-2, an example of a multi-antenna structure 100 of the antenna PCB 20 includes the antennas 38, 40, feed mechanisms 42, 44, a ground plane 46, a substrate 48, and an isolator 50. In the example multi-antenna structure 100, the ground plane 46, the antennas 38, 40, and the isolator 50 are disposed on the substrate 48 and are thus co-planar. The isolator is electrically coupled to the ground plane 46. The feed mechanisms 42, 44 may be partially disposed on the substrate 48, and partially in or through the substrate 48. The feed mechanisms 42, 44 are configured to receive energy from a transmission lines and excite the antennas 38, 40 with this energy. The feed mechanisms 42, 44 may receive energy from any of a variety of types of transmission lines, such as microstrip, stripline, or coaxial. Further, while the two feed mechanisms 42, 44 are preferably the same, this is not required. The feed mechanisms 42, 44 are coupled to the transceiver 33 (not shown in FIG. 3) that is configured to supply communication signals to the feed mechanisms 42, 44 for radiation by the antennas 38, 40, and that is configured to receive signals received by the antennas 38, 40 and provided to the transceiver 33 by the feed mechanisms 42, 44. The isolator 50 is coupled to the ground plane 46 and configured to suppress mutual coupling between the antennas 38, 40, especially in an operational frequency range over which the antennas are configured to radiate significantly. For example, the operational frequency range may be the frequencies where more than a threshold amount (e.g., half, two thirds, etc.) of the energy delivered to the antennas 38, 40 by the feed mechanisms 42, 44 is radiated, or at least not reflected back to the feed mechanisms 42, 44. The isolator 50 does not necessarily completely isolate the antennas 38, 40 from each other, but is configured to inhibit electrical coupling between the antennas 38, 40, in particular the isolator 50 is configured to inhibit energy radiated by either of the antennas 38, 40 from coupling to and inducing current in the other antenna 38, 40. The isolator 50, in the example shown in FIG. 3, is a resonant structure although a non-resonant structure may also be used as an isolator to suppress mutual coupling between the antennas 38, 40.

In the example shown in FIG. 3, the antennas 38, 40 are micro-strip antennas that are co-planar with the ground plane 46. Further, in this example, the antennas 38, 40 are both F-shaped with respective base portions 35, 39 each extending in a direction away from and substantially transverse to (e.g., 90°±10° relative to) an upper edge 64 of the ground plane 46, and respective upper portions 37₁₋₂, 41₁₋₂ each extending substantially parallel to (e.g., 0°±10° relative to) the upper edge 64 and in a direction away from their respective base portions 35, 39 in substantially opposite directions (e.g., 180°±10° relative to). The antennas 38, 40 are displaced from each other by a length 140.

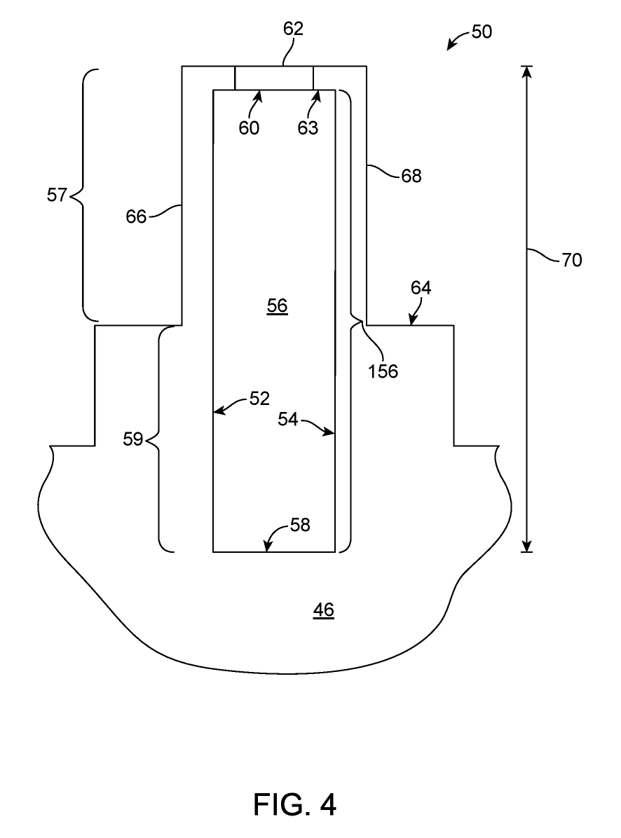

Referring also to FIG. 4, the isolator 50 comprises portions of the ground plane 46 that define side walls 52, 54 of a slot 56, a conductive end wall 58 defining one terminus of the slot 56, and a capacitive end wall 60 defining another terminus of the slot 56. The slot 56 is an absence of conductive material on the substrate 48, here between the side walls 52, 54 of the ground plane 46 and arms 66, 68 of the ground plane 46. While the slot 56 is shown as being straight and of a uniform width (distance between the side walls 52, 54), other shapes of slots may be used, e.g., non-straight (e.g., curved) and/or of varying (non-uniform) width. The side walls 52, 54 are opposing (i.e., facing each other) electrically-conductive walls. The conductive end wall 58 is a short that couples the side wall 52 to the side wall 54 to define a bottom end of the slot 56, with the bottom end being below the upper edge 64 of the ground plane 46. The ground plane 46 is configured to define the slot 56 with dimensions that will help the isolator 50 inhibit electrical coupling between the antennas 38, 40. The slot 56 has a length 156 that is substantially transverse to (e.g., 90°±10° relative to) the length 140 and substantially parallel to (e.g., 0°±10° relative to) the base portions 35, 39. Further, the isolator 50 includes a capacitor 62 that is coupled to the ground plane 46 and defines the capacitive end wall 60. As shown, the capacitor 62 forms a major portion of an upper end wall 63 of the slot 56, with portions of the ground plane 46 constituting the remainder of the upper end wall 63. Alternatively, the capacitor 62 could define the entire upper end wall 63 of the slot 56.

Dimensions of the slot 56 and a capacitance value of the capacitor 62 help the isolator inhibit mutual coupling of the antennas 38, 40. The capacitance value of the capacitor 62 and the dimensions of the slot 56 affect a resonant frequency of the isolator 50 and thus may affect the frequency range over which the isolator 50 best isolates the antennas 38, 40. The ground plane 46 is preferably configured such that the dimensions of the slot 56, in combination with a value of the capacitor 62, will increase the isolation (i.e., decrease the mutual coupling) between the antennas 38, 40 such that the antennas 38, 40 will be adequately isolated over a desired operational frequency band of the antennas 38, 40. For example, the isolator 50 may increase the isolation of the antennas 38, 40 more than an isolation threshold amount (e.g., 3 dB, or 5 dB, or 7 dB) over a desired operational frequency range of the antennas 38, 40. That is, log(S₂₁)₁≦log(S₂₁)−Iₜₕ, where Iₜₕ is an isolation threshold amount, (S₂₁)₁ is the forward voltage gain coefficient with the isolator 50 used, and log(S₂₁) is the forward voltage gain coefficient without the isolator 50 used.

The use of the capacitor 62 to define the end wall 63 of the slot 56 may allow a length of the slot 56 to be less than if the capacitor 62 was not used to achieve the same resonant frequency for the isolator 50. For example, a length 70 of the slot 56 may be less than one eighth (⅛) of a wavelength at a resonant frequency of the isolator 50 or a center frequency of a frequency range over which the antennas 38, 40 are configured to radiate (e.g., at least a threshold amount of energy received at the feed mechanisms 42, 44), or even less than one tenth ( 1/10) of the wavelength at the resonant frequency of the isolator 50 or the center frequency of the antennas 38, 40. The wavelengths here may be free-space wavelengths or wavelengths in the substrate 48.

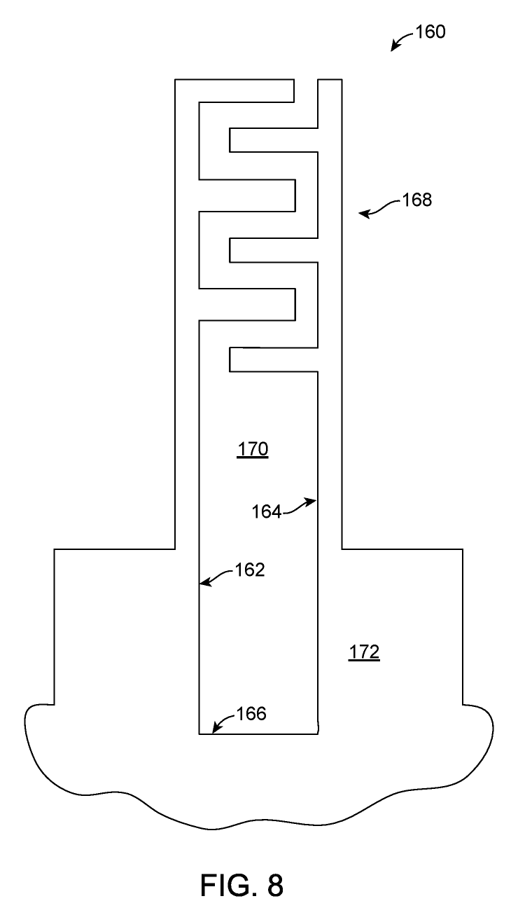

As shown, the capacitor 62 is a lumped capacitor with a fixed capacitance value, but this is an example only and other forms of capacitances may be used in the isolator 50 or in other isolators such as, but not limited to, those discussed below. For example, the capacitor 62 may be a variable capacitor, an interdigitated capacitor as shown in FIG. 8, or other type of capacitor. As shown in FIG. 8, an isolator 160 comprises a slot 170 defined by portions of a ground plane 172 configured to provide side walls 162, 164, and an end wall 166, and a capacitive end provided by a capacitor 168 which is an interdigitated capacitor.

Returning to FIG. 4, with further reference to FIG. 3, the isolator 50 extends above the upper edge 64 of the ground plane 46. As shown in FIG. 3, the ground plane 46 extends to the upper edge 64 adjacent the antennas 38, 40. The isolator 50, however, extends above the upper edge 64. Above the upper edge 64, the ground plane 46 has two arms 66, 68 that bound the sides of the slot 56, and in this example portions of the end wall 63. The arms 66, 68 define an upper region 57 of the slot 56 and provide the side walls 52, 54 in the upper region of the slot 56. The arms 66, 68 are narrower than portions of the ground plane 46 below the upper edge 64 (i.e., widths of the arms 66, 68 are smaller than widths of the ground plane 46 adjacent a lower portion 59 of the slot 56), although the ground plane 46 could be configured differently, for example with the arms 66, 68 being wider than as shown in FIG. 4. The arms 66, 68 provide the side walls 52, 54 in the upper region 57 of the slot 56 and define the upper region of the slot 56 between the antennas 38, 40. That is, the arms 66, 68 are disposed on the substrate 48 between the antennas 38, 40.

The isolator 50 may serve dual purposes of inhibiting mutual coupling between the antennas 38, 40 and radiating energy. Depending on the configuration of the isolator 50, e.g., the dimensions of the slot 56 and the capacitance value of the capacitor 62, the isolator 50 may cause the antennas 38, 40 to radiate energy in an alternate frequency band outside of their normal operational frequency band and the isolator 50 may receive radiated energy from the antennas 38, 40, and may re-radiate at least some of this energy. The antennas 38, 40 may be provided with signals, by the processor 32 via the transceiver 33, in the alternate frequency band. The isolator 50 may receive energy from these signals and radiate the signals. Thus, the antennas 38, 40 and the isolator 50 may be used as a dual-band radiator. Other configurations of isolators, such as the isolators discussed below, may also receive and re-radiate energy (e.g., communication signals provided by the processor 32 to the antennas 38, 40 via the transceiver 33).

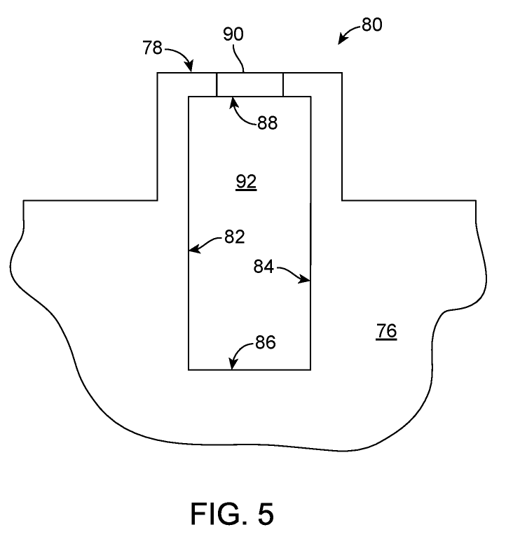

Referring to FIG. 5, with further reference to FIG. 3, an isolator 80 may be used instead of the isolator 50 shown in FIG. 3. The isolator 80 comprises portions of a ground plane 76 configured to provide side walls 82, 84, and an end wall 86, and a capacitive end wall 88 provided by a capacitor 90. The walls 82, 84, 86, 88 define a slot 92. The isolator 80 does not extend above an upper edge 78 of the ground plane 76. Alternatively, the isolator 80 could be configured with the capacitor 90 extending above the upper edge 78 while the slot 92 is disposed at or below the upper edge 78. As with the isolator 50, the ground plane 76 and the capacitor 90 are configured such that the dimensions of the slot 92 and the capacitance value of the capacitor 90 combine to form the isolator 80 as a resonant structure that inhibits mutual coupling of the antennas 38, 40.

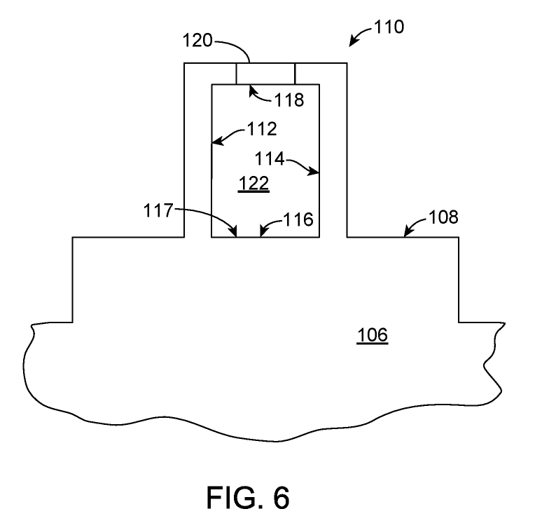

Referring to FIG. 6, with further reference to FIG. 3, an isolator 110 may be used instead of the isolator 50 shown in FIG. 3. The isolator 110 comprises portions of a ground plane 106 configured to provide side walls 112, 114, and an end wall 116, and a capacitive end wall 118 provided by a capacitor 120. The walls 112, 114, 116, 118 define a slot 122. The isolator 110 extends only above an upper edge 108 of the ground plane 106, with the wall 116 defining an end 117 of the slot 122 that is collinear with the upper edge 108 of the ground plane 106. As with the isolator 50, the ground plane 106 and the capacitor 120 are configured such that the dimensions of the slot 122 and the capacitance value of the capacitor 120 combine to form the isolator 110 as a resonant structure that inhibits mutual coupling of the antennas 38, 40.

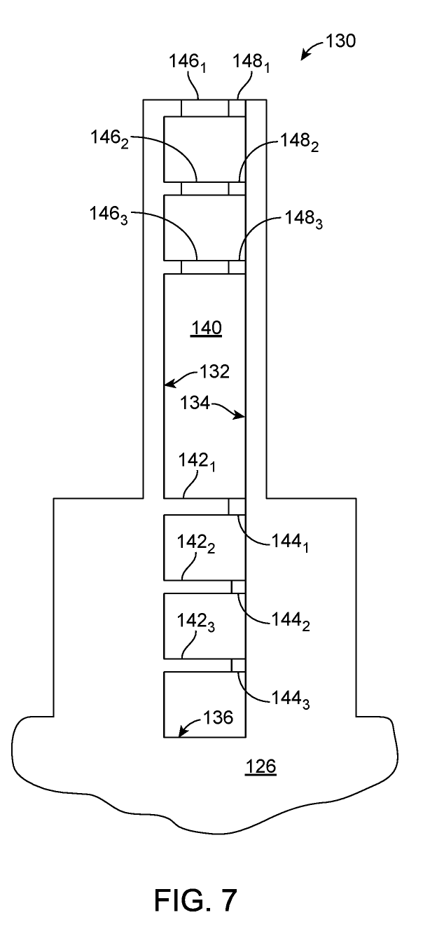

Referring to FIG. 7, with further reference to FIGS. 2-3, an isolator 130 may be used instead of the isolator 50 shown in FIG. 3. The isolator 130 comprises portions of a ground plane 126 configured to provide side walls 132, 134 of a slot 140. The isolator 130 is configured to provide a selectable length of the slot 140, and in particular providing a selectable location of a conductive end wall and a selectable location and/or capacitance value of a capacitive end wall. The selectable locations of end walls and possibly capacitance values provides a tuning mechanism for the isolator 130, although other tuning mechanisms may be used, e.g., that include more or fewer selectable shorts and/or capacitors than discussed below, or using only selectable shorts or only selectable capacitors, etc.

The location of the conductive end wall of the slot 140 is provided by a selected one of selectable shorts 142 and a corresponding one of switches 144, or a conductive end wall 136 provided by the ground plane 126. Each of the selectable shorts 142 is coupled to the side wall 132 provided by the ground plane 126 and selectively coupled, via the corresponding selectable switch 144, to the side wall 134 provided by the ground plane 126. Each of the selectable shorts 142₁₋₃ is disposed a different distance from a proximal end of the slot 140, i.e., the end wall 136. Each of the selectable switches 144 is coupled to the processor 32 (see FIG. 2) and is configured to be activated (selected, closed) to couple the side wall 134 of the ground plane 126 to the corresponding selectable short 142 to form a conductive coupling of the side wall 132 to the side wall 134 and thereby to define an end to the slot 140. A closed switch 144 and a corresponding one of the selectable shorts 142 form a low-impedance (zero-ohm or near-zero-ohm) coupling of the ground plane 126 to itself physically across the slot 140. In the example shown in FIG. 7, the isolator 130 includes three selectable shorts 142₁₋₃ and three corresponding switches 144₁₋₃, but this is an example only and more or fewer selectable shorts 142 and corresponding switches 144 may be used.

The location of the capacitive end wall of the slot 140 is provided by a selected one of selectable capacitors 146 and a corresponding one of switches 148. Each of the selectable capacitors 146 is coupled to the side wall 132 provided by the ground plane 126 and selectively coupled, via the corresponding selectable switch 148, to the side wall 134 provided by the ground plane 126. Each of the selectable switches 148 is coupled to the processor 32 (see FIG. 2) and is configured to be activated (selected, closed) to couple the side wall 134 of the ground plane 126 to the corresponding selectable capacitor 146 to form the capacitive end wall of the slot 140. A closed switch 148 and a corresponding one of the selectable capacitors 146 form a capacitive coupling of the ground plane 126 to itself (i.e., coupling the side wall 132 to the side wall 134) physically across the slot 140. The capacitor 146 may, but need not, be in physical contact with the substrate in the slot 140. In the example shown in FIG. 7, the isolator 130 includes three selectable capacitors 146₁₋₃ and three corresponding switches 148₁₋₃, but this is an example only and more or fewer selectable capacitors 146 and corresponding switches 148 may be used.

The capacitance values of the capacitors 146₁₋₃ may not all be the same. The capacitance values of at least two of the capacitors 146₁₋₃ may be different, and indeed the capacitance value of each of the capacitors 146₁₋₃ may be unique within the isolator 130. For example, the capacitance value of the capacitor 146₃ may be higher than the capacitance value of the capacitors 146 that would make the slot 140 longer, i.e., of the capacitors 146₁₋₂. The capacitance value of at least two of the capacitors 146 may be the same or nearly the same to help tune the resonance of the isolator 130 by enabling selection of different lengths of the slot 140 with the same (or nearly the same) capacitive termination. Indeed, all of the capacitors 146 may have the same capacitance value.

Which of the shorts 142 and which of the capacitors 146 to use to provide the conductive end wall and the capacitive end wall of the slot 140 may be determined iteratively. For example, the processor 32 may be configured to actuate one of the switches 144₁₋₃ and one of the switches 148₁₋₃, to actuate each of the antennas 38, 40 (e.g., by sending a signal to the transceiver intended for one of the antennas 38, 40) in turn, and to monitor energy received by the non-actuated one of the antennas 38, 40 (the S₂₁ or the S₁₂) and/or to monitor energy reflected by the actuated one of the antennas 38, 40 (e.g., the S₁₁ or S₂₂, i.e., the input port voltage reflection coefficient at either of the feed mechanisms 42. 44). The processor 32 may determine to use the combination of one of the shorts 142₁₋₃ and one of the capacitors 146₁₋₃ that provides the most-desirable operational characteristic(s), e.g., the best isolation characteristic(s), or the best reflected energy characteristic(s), or the best combination of these. For example, the processor 32 may determine the best S₂₁ over the operational frequency band of the antennas 38, 40, or the best combination of S₂₁ and S₁₁ over the operational frequency band of the antennas 38, 40, or the best combination of S₂₂ and S₁₂ over the operational frequency band of the antennas 38, 40, or the best combination of S₂₁, S₁₂, S₁₁, and S₂₂ over the operational frequency band of the antennas 38, 40, or another criterion or other criteria. The processor 32 may be configured in a variety of ways to determine what is considered to be the “best” of the determined criterion (criteria). As examples, the best S₂₁ may be considered to be the lowest average S₂₁, or the lowest peak S₂₁, or the lowest center-frequency S₂₁ as long as the peak S₂₁ is below a threshold. As other examples, the best S₁₁ may be considered to be the lowest average S₁₁, or the lowest peak S₁₁, or the lowest center-frequency S₁₁ as long as the peak S₁₁ is below a threshold. As another example, the best combination of S₂₁, S₁₂, S₁₁, and S₂₂ may be considered to be the lowest average of these parameters as long as none of the parameters exceeds a respective threshold. The discussion herein, however, is not limited to any of these examples, and numerous other techniques for determining what is considered to be the most-desirable operational characteristic(s) may be used and the processor 32 may be configured to implement any such technique(s).

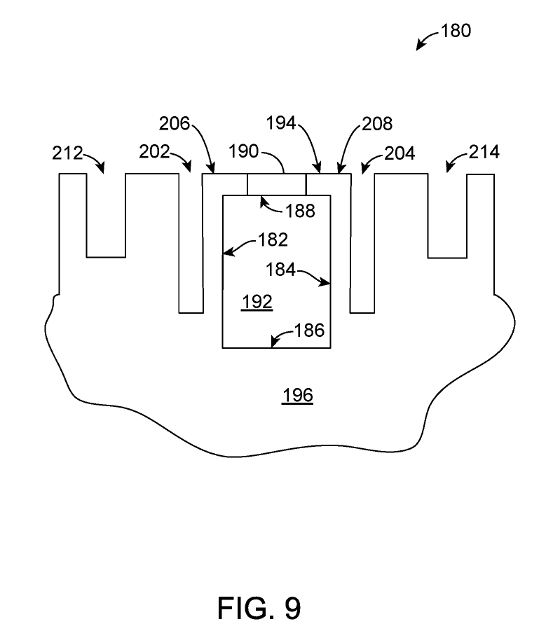

Referring to FIG. 9, an example isolator 180 includes portions of a ground plane 196 configured to provide side walls 182, 184, and an end wall 186, and a capacitive end wall 188 provided by a capacitor 190. The walls 182, 184, 186, 188 define an isolating slot 192 for isolating antennas such as the antennas 38, 40 shown in FIG. 3. The isolator 180 does not extend beyond an edge 194 of the ground plane 196, with the wall 188 defining an end of the slot 192 that is disposed nearest the upper edge 194 of the ground plane 196. Alternatively, the end nearest the upper edge 194 could be collinear with the upper edge 194 of the ground plane 196. Further, the isolator 180 includes separating slots 202, 204 defined by the ground plane 196 that separate portions 206, 208 of the ground plane 196, that define the isolating slot 192, from other portions of the ground plane 196 that are further away from the isolating slot 192 than the portions 206, 208. As shown, the separating slots 202, 204 extend less into the ground plane 196 from the upper edge 194 than the isolating slot 192, but this is only an example and the separating slots 202, 204 could extend below the wall 186. Further, the separating slots 202, 204 could be used in other configurations of isolators, e.g., isolators where an isolating slot extends above an upper edge of a ground plane. The isolator 180 also includes feed openings 212, 214 provided by the ground plane 196 to accommodate feed mechanisms (not shown).

The isolators discussed above provide examples of means for inhibiting electrical coupling between antennas that share a ground plane, although other configurations may be used. The various conductive end walls, including fixed end walls and selectable shorts provide means for providing an electrically-conductive terminus to a slot, although other configurations may be used. The various capacitors, including lumped capacitors, variable capacitors, selectable capacitors, and interdigitated capacitors provide examples of means for providing a capacitive terminus to the slot, although other configurations may be used. Further, particular configurations of slots, end walls, side walls, etc. are not limited to the example combinations of features shown and discussed. That is, features shown in the various examples may be used in different combinations other than those shown.

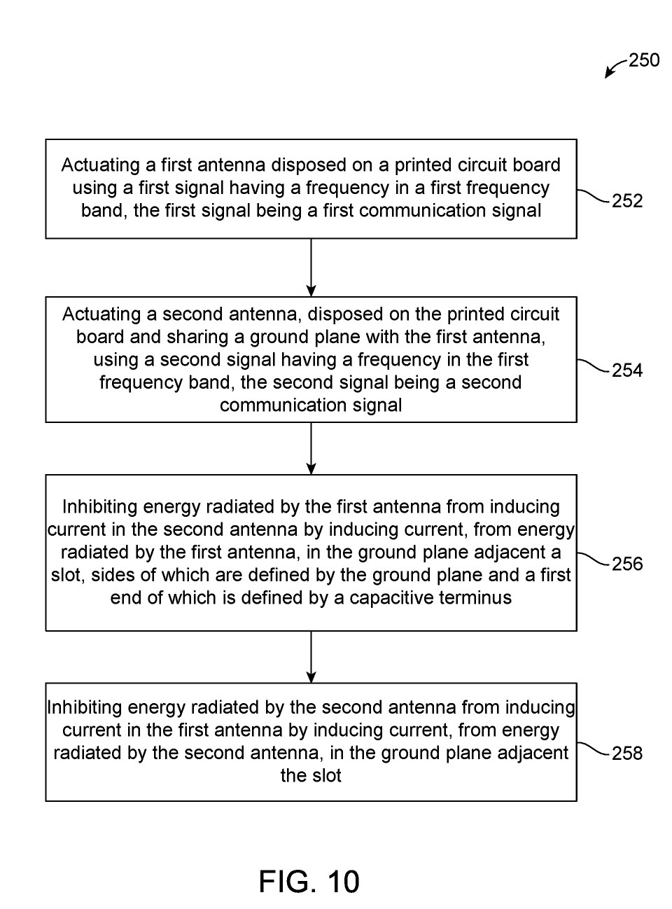

Referring to FIG. 10, with further reference to FIGS. 1-8, a method 250 of communicating from antennas disposed on a printed circuit board includes the stages shown. The method 250 is, however, an example only and not limiting. The method 250 can be altered, e.g., by having stages added, removed, rearranged, combined, performed concurrently, and/or having single stages split into multiple stages.

At stage 252, the method 250 includes actuating a first antenna disposed on a printed circuit board using a first signal having a frequency in a first frequency band, the first signal being a first communication signal. The processor 32 sends communication signals via the transceiver 33 to the antenna 38 on the PCB 20. The antenna 38 radiates the communication signals for reception by appropriate entities, e.g., cellular base stations, Wi-Fi access points, etc. The communication signals have frequencies in the operational frequency band of the antenna 38.

At stage 254, the method 250 includes actuating a second antenna, disposed on the printed circuit board and sharing a ground plane with the first antenna, using a second signal having a frequency in the first frequency band, the second signal being a second communication signal. The processor 32 sends communication signals via the transceiver 33 to the antenna 40 on the PCB 20. The antenna 40 radiates the communication signals for reception by appropriate entities, e.g., cellular base stations, Wi-Fi access points, etc. The communication signals have frequencies in the operational frequency band of the antenna 40. The communications signals sent by the processor 32 to the antenna 40 may be identical to the communication signals sent to the antenna 38, possibly being the same signals split in two and sent to the antennas 38, 40. For example, the antennas 38, 40 may be used in a system that implements multiple input multiple output (MIMO) transmission and/or reception, for example 4×4 MIMO or another form of MIMO.

At stages 256 and 258, the method 250 includes inhibiting energy radiated by the first antenna from inducing current in the second antenna by inducing current, from energy radiated by the first antenna, in the ground plane adjacent a slot, sides of which are defined by the ground plane and a first end of which is defined by a capacitive terminus, and inhibiting energy radiated by the second antenna from inducing current in the first antenna by inducing current, from energy radiated by the second antenna, in the ground plane adjacent the slot. The isolator 50, or other isolator, inhibits mutual coupling of the antennas 38, 40, e.g., by receiving energy transmitted by each of the antennas 38, 40 that would be coupled to the other antenna 38, 40 in the absence of the isolator 50. The isolator 50 prevents at least some of the energy transmitted by each of the antennas 38, 40 from reaching the other antenna 38, 40 that would reach the other antenna 38, 40 in the absence of the isolator 50. The processor 32 may tune the isolator, e.g., by selecting a capacitance of a variable capacitor of the isolator, by selecting a location of a conductive terminus of a slot provided by the isolator, and/or by selecting a location and/or a capacitance value of a capacitive terminus of the slot. The processor 32 may vary one or more of these parameters, e.g., by selecting the parameter(s), measuring mutual coupling and/or reflected energy, repeating the selecting and measuring, and selecting the parameter(s) that yield the most-desirable operational characteristic(s) or combination of operational characteristics.

The method 250 may include further stages. For example, the method 250 may include actuating the first antenna with another signal or signal that has a frequency in a second frequency band that is separate from the first frequency band and dependent on a resonance frequency of the slot, and the second antenna may be similarly actuated. For example, the antennas 38, 40 may be actuated with communication signals having frequencies outside of the operational frequency band of the antennas 38, 40. Energy from these signals may be coupled to the isolator, and the isolator may radiate the signals, acting as an antenna. In this way, dual-band communications may be provided.

Experimental Results

Examples of the antennas 38, 40 and the isolator 50 were computer simulated and prototypes were built with and without the isolator 50 and tested. In the computer-simulated example, the slot 56 was 0.8 mm wide and 9.7 mm long, the capacitor 62 was a lumped capacitor having a capacitance of 0.1 pF, and the antennas 38, 40 were designed for an operational frequency range of 3.4-3.8 GHz. Without the isolator, over the operational frequency band, the S₁₁ and S₂₂ had maxima of about −5 dB and minima of about −11 dB and the S₁₂ and S₂₁ had maxima of about −6.7 dB and minima of about −9.6 dB. With the isolator, over the operational frequency band, the S₁₁ and S₂₂ had maxima of about −6.4 dB and minima of about −11 dB and the S₁₂ and S₂₁ had maxima of about −14.2 dB and minima of about −31.5 dB. In the prototype, the slot 56 was 0.75 mm wide and 8.0 mm long, the capacitor 62 was a lumped capacitor having a capacitance of 0.1 pF, and the antennas 38, 40 were designed for an operational frequency range of 3.4-3.8 GHz. Without the isolator, over the operational frequency band, the S₁₁ and S₂₂ had maxima of about −5.7 dB and minima of about −8.5 dB and the S₁₂ and S₂₁ had maxima of about −7.0 dB and minima of about −9.5 dB. With the isolator, over the operational frequency band, the S₁₁ and S₂₂ had maxima of about −6.2 dB and minima of about −11.5 dB and the S₁₂ and S₂₁ had maxima of about −8.5 dB and minima of about −31.7 dB. The computer-simulated system and the prototyped system are examples, and the discussion herein, and particularly the claims, are not limited to these examples.

Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. A multi-antenna structure comprising:
a substrate;
a ground plane disposed on the substrate;
a signal feed mechanism;
a first antenna coupled to the ground plane via the signal feed mechanism;
a second antenna coupled to the ground plane via the signal feed mechanism; and
an isolator electrically coupled to the ground plane and disposed between the first antenna and the second antenna, the isolator including:
a first side wall and a second side wall that define a slot;
a short coupled to the first side wall and to the second side wall to define a first end of the slot; and
a capacitor configured and disposed to be coupled to the first side wall and to the second side wall to define a second end of the slot.

2. The structure of claim 1, wherein the first antenna is configured to radiate, over a frequency range, at least a threshold amount of energy received from the signal feed mechanism, and wherein a length of the slot from the first end of the slot to the second end of the slot is less than an eighth of a wavelength at a center frequency of the frequency range.

3. The structure of claim 1, wherein the capacitor is one of a plurality of selectable capacitors each disposed at least partially across the slot and each disposed a respective different distance from the first end.

4. The structure of claim 3, wherein at least two of the plurality of selectable capacitors have different capacitance values.

5. The structure of claim 1, further comprising a plurality of selectable shorts each disposed a respective different distance from the first end and each configured to define a new first end of the slot when selected.

6. The structure of claim 1, wherein the first antenna, the second antenna, the first side wall, and the second side wall are co-planar, and the first side wall and the second side wall define at least a portion of the slot between the first antenna and the second antenna.

7. The structure of claim 6, wherein:
the portion of the slot between the first antenna and the second antenna is a first portion of the slot;
a first portion of the first side wall and a first portion of the second side wall define the first portion of the slot;
a second portion of the first side wall and a second portion of the second side wall define a second portion of the slot; and
each of the first portion of the first side wall and the first portion of the second side wall has a respective first width transverse to a length of the slot that is smaller than a respective second width of the second portion of the first side wall and the second portion of the second side wall.

8. The structure of claim 1, wherein the capacitor is a lumped capacitor.

9. The structure of claim 1, wherein the capacitor is a variable capacitor.

10. The structure of claim 1, wherein the capacitor is an interdigitated capacitor.

11. The structure of claim 1, wherein the ground plane has a first edge, wherein the first antenna and the second extend beyond the first edge, and wherein the first end of the slot is disposed on an opposite side of the first edge as compared to first antenna.

12. The structure of claim 1, wherein the ground plane has a first edge, wherein the first antenna and the second antenna extend beyond the first edge, and wherein the first end of the slot is disposed collinear with the first edge of the ground plane.

13. The structure of claim 1, wherein the ground plane has a first edge, wherein the first antenna and the second antenna extend beyond the first edge, and wherein the second end of the slot is disposed collinear with the first edge or on an opposite side of the first edge as compared to the first antenna.

14. A printed circuit board comprising:
a dielectric substrate;
a first antenna disposed on a first side of the dielectric substrate;
a second antenna disposed on the first side of the dielectric substrate, co-planar with the first antenna and displaced from the first antenna by a first length;
a ground plane disposed on the first side of the dielectric substrate, co-planar with the first antenna and co-planar with the second antenna, the ground plane defining a first side of a slot, a second side of the slot, and a proximal end of the slot, the slot having a second length that is substantially transverse to the first length; and
a tuning mechanism comprising:
at least one selectable short configured to be selectively coupled to the ground plane across the slot; or
a plurality of selectable capacitances each configured to be selectively coupled to the ground plane across the slot; or
a combination thereof.

15. The printed circuit board of claim 14, wherein the tuning mechanism comprises the plurality of selectable capacitances, each of the plurality of selectable capacitances being disposed a respective different distance from the proximal end of the slot.

16. The printed circuit board of claim 15, wherein each of the plurality of selectable capacitances has a capacitance value unique to the plurality of selectable capacitors.

17. The printed circuit board of claim 14, wherein the tuning mechanism comprises the at least one selectable short, wherein the at least one selectable short comprises a plurality of selectable shorts each disposed a respective different distance from the proximal end of the slot.

18. The printed circuit board of claim 14, wherein the ground plane defines the slot between the first antenna and the second antenna.

19. The printed circuit board of claim 14, wherein:
the first antenna is F-shaped, with a first base portion extending transverse to an edge of the ground plane, and with upper portions extending parallel to the edge of the ground plane;
the second antenna is F-shaped, with a second base portion extending transverse to the edge of the ground plane, and with upper portions extending parallel to the edge of the ground plane in a direction substantially opposite of the upper portions of the first antenna; and
wherein the ground plane defines the slot substantially parallel to and between the first base portion of the first antenna and the second base portion of the second antenna.

20. A printed circuit board comprising:
a dielectric substrate;
a first antenna disposed on a first side of the dielectric substrate;
a second antenna disposed on the first side of the dielectric substrate, co-planar with the first antenna and displaced from the first antenna by a first length;
a ground plane disposed on the first side of the dielectric substrate, co-planar with the first antenna and co-planar with the second antenna; and
means for inhibiting electrical coupling between the first antenna and the second antenna, the means for inhibiting comprising two opposing electrically-conductive walls providing a slot, means for providing an electrically-conductive first terminus of the slot, and capacitive means for providing a capacitive second terminus of the slot.

21. The printed circuit board of claim 20, wherein the capacitive means comprise means for selecting a capacitance of the capacitive second terminus.

22. The printed circuit board of claim 21, wherein the capacitive means comprise means for selecting a location of the capacitive second terminus.

23. The printed circuit board of claim 20, wherein the means for inhibiting comprise means for selecting a location of the first terminus.

24. The printed circuit board of claim 20, wherein the means for inhibiting are for inhibiting electrical coupling between the first antenna and the second antenna over a first frequency band, the means for inhibiting being further for radiating energy over a second frequency band that is separate from the first frequency band.

25. The printed circuit board of claim 20, wherein the means for inhibiting comprise a portion of the ground plane providing the two opposing electrically-conductive walls.

26. A method of communicating from a first antenna and a second antenna disposed on a printed circuit board, the method comprising:
actuating the first antenna disposed on the printed circuit board using a first signal having a first frequency in a first frequency band, the first signal being a first communication signal;
actuating the second antenna, disposed on the printed circuit board and sharing a ground plane with the first antenna, using a second signal having a second frequency in the first frequency band, the second signal being a second communication signal;
inhibiting energy radiated by the first antenna from inducing current in the second antenna by receiving energy, radiated by the first antenna, at the ground plane in a region of the ground plane adjacent a slot, sides of the slot being defined by the ground plane and a first end of the slot being defined by a capacitive terminus; and
inhibiting energy radiated by the second antenna from inducing current in the first antenna by receiving energy, radiated by the second antenna, at the ground plane in the region adjacent the slot.

27. The method of claim 26, further comprising:
actuating the first antenna using a third signal having a third frequency in a second frequency band that is separate from the first frequency band, the third signal being a third communication signal, the second frequency band depending on a resonance frequency of the slot; and
actuating the second antenna using a fourth signal having a fourth frequency in the second frequency band, the fourth signal being a fourth communication signal.

28. The method of claim 27, wherein the first signal is the second signal and the third signal is the fourth signal.

29. The method of claim 26, further comprising:
selecting a capacitance value of the capacitive terminus; or
selecting a location of the capacitive terminus; or
selecting a location of a second end of the slot, the second end being an electrically-conductive terminus; or
a combination thereof.
